(19) United States
(12) Patent Application Publication
(10) Pub. No.: US 2008/0181231 A1
(43) Pub. Date: Jul. 31, 2008

(54) DATA PROCESSING DEVICE, DATA PROCESSING METHOD AND DATA PROCESSING PROGRAM

(75) Inventors: Kazumasa SONODA, Fukuoka (JP); Satoru Mashima, Fukuoka (JP); Hideyuki Kudou, Fukuoka (JP); Akira Hashimoto, Fukuoka (JP); Takahiro Yamamoto, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/969,581

(22) Filed: Jan. 4, 2008

(30) Foreign Application Priority Data
Jan. 19, 2007 (JP) JP2007-010606

(51) Int. Cl. H04L 12/56

(52) U.S. Cl. 370/395.1

(57) ABSTRACT

A data processing device connected to another data processing device through an asynchronous network to receive/transmit data from/to the other data processing device. The data processing device monitors an accumulation amount of a reception buffer for receiving data transmitted from the other data processing device, controls a self reception data processing clock based upon the monitored accumulation amount, transmits to the other data processing device transmission clock control information controlling a transmission clock in the other data processing device based upon the monitored accumulation amount, and controlling a self transmission clock based upon the clock control information transmitted from the other data processing device.

### CROSS-REFERENCE TO RELATED APPLICATIONS

This application is related to and claims priority to Japanese patent application no. 2007-10606 filed on Jan. 19.2007 in the Japan Patent Office, and incorporated by reference herein.

### BACKGROUND

### Field

The embodiments relate to a data processing device that is connected to another data processing device through an asynchronous network and receives/transmits data from/to the other data processing device, a data processing method and a data processing program.

### SUMMARY

According to an aspect of an embodiment, a data processing device that is connected to another data processing device through an asynchronous network and receives/transmits data from/to the other data processing device, includes an accumulation amount monitor for monitoring an accumulation amount of a reception buffer for receiving data transmitted from the other data processing device; a reception data processing clock controller for controlling a self reception data processing clock on the basis of the accumulation amount monitored by the accumulation amount monitor; a clock information transmitter for transmitting to the other data processing device transmission clock control information for controlling a transmission clock in the other data processing device on the basis of the accumulation amount monitored by the accumulation amount monitor; and a transmission clock controller for controlling a self transmission clock on the basis of the clock control information transmitted from the other data processing device.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram showing the general outline and feature of a packet transmission system according to a first embodiment;

FIG. 2 is a block diagram showing the construction of a packet processing device according to the first embodiment;

FIG. 3 is a sequence diagram showing the flow of processing of the packet transmission system according to the first embodiment;

FIG. 4 is a flowchart showing the processing of monitoring the accumulation amount of a reception buffer by the packet processing device according to the first embodiment;

FIG. 5 is a block diagram showing the construction of a packet processing device according to a second embodiment;

FIG. 6 is a diagram showing an example of a relay packet;

FIG. 7 is a diagram showing an example of a packet provided with a tag;

FIG. 8 is a diagram showing separation of the tag from the packet;

FIG. 9 is a block diagram showing the construction of a packet processing device according to a third embodiment;

FIG. 10 is a diagram showing an example of an inter-packet gap;

FIG. 11 is a diagram showing an example of a control packet in the inter-packet gap;

FIG. 12 is a diagram showing extraction of control information; and

FIG. 13 is a diagram showing a computer executing a packet processing program.

### DETAILED DESCRIPTION OF THE PREFERRED EMBODIMENTS

Preferred embodiments of a data processing device, a data processing method and a data processing program according to the embodiments will be described hereunder with reference to the figures.

### First Embodiment

In this embodiment, the outline and feature of a packet transmission system according to a first embodiment, the construction of a packet transmission system and the flow of processing will be successively described in this order, and finally an effect achieved by the first embodiment will be described.

Outline and feature of the packet transmission system according to the first embodiment.

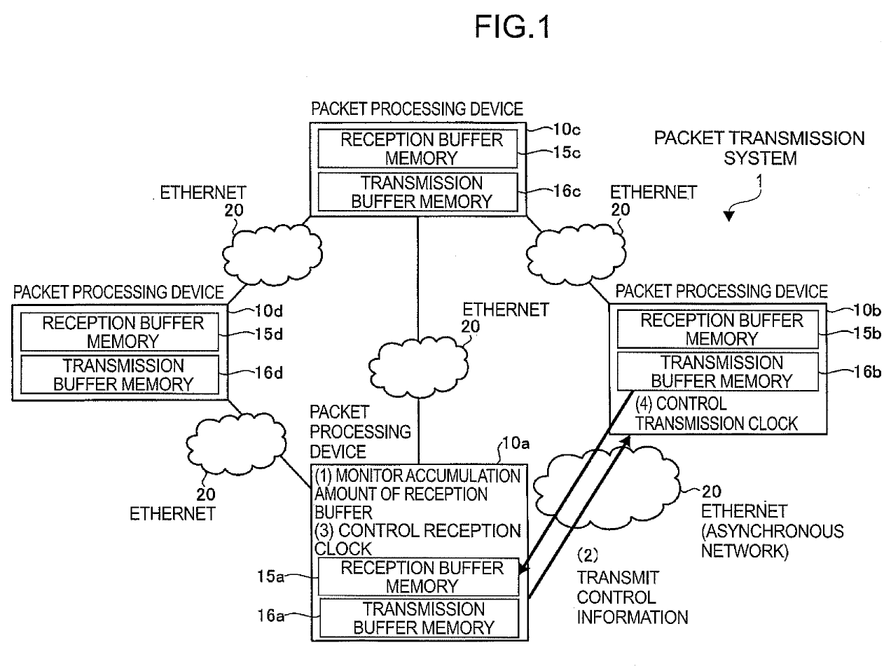

First, the outline and feature of the packet transmission system according to the first embodiment will be described with reference to FIG. 1. FIG. 1 is a diagram showing the outline and feature of the packet transmission system according to the first embodiment.

The outline of the packet transmission system 1 of the first embodiment resides in that a packet processing device constituting the packet transmission system 1 is connected to other packet processing devices through ETHERNET as an asynchronous network and receives packets from the other packet processing devices or transmits packets to the other packet processing devices. The main feature of the packet processing device resides in that packets are prevented from being missing and also the clock frequency of the overall network is prevented from increasing.

The main feature of the packet processing device as described above will be described in detail.

The packet transmission system 1 of this embodiment includes plural packet processing devices (packet processing devices 10a to 10d) as shown in FIG. 1, and each packet processing device is equipped with a reception buffer memory 15 for receiving packets transmitted from the other packet processing devices, and a transmission buffer memory 16 for storing packets to be transmitted to the other packet processing devices.

In the construction as described above, the packet processing device 10a monitors the accumulation amount of the reception buffer 15a while receiving packets transmitted from the packet processing device 10b (see (1) of FIG. 1). Then, on the basis of the monitored accumulation amount of the reception buffer, the packet processing device 10a transmits control information instructing control of a transmission clock to the packet processing device 10b ((2) of FIG. 1). Specifically, when the accumulation amount of the reception buffer is equal to a predetermined upper limit threshold value or more, the packet processing device 10a transmits control information instructing reduction of the clock speed to the packet processing device 10b.

Subsequently, the packet processing device 10a controls its own reception data processing clock on the basis of the monitored accumulation amount of the reception buffer (see (3) of FIG. 1). Specifically, when the accumulation amount of the reception buffer is equal to a predetermined upper limit threshold value or more, the packet processing device 10a controls its own clock speed so that the clock speed concerned increases. On the other hand, when the accumulation amount of the reception buffer is equal to a predetermined lower limit threshold value or less, the packet processing device 10a controls its own clock speed so that the clock speed concerned decreases.

The packet processing device 10b controls its own transmission clock on the basis of the control information transmitted from the packet processing device 10a (see (4) of FIG. 1). Specifically, the packet processing device 10b receives the control information and reduces the clock speed. The packet processing device 10b continues to reduce the clock speed until it receives control information for permitting release of the reduction of the clock speed from the packet processing device 10a.

As described above, each packet processing device 10 controls the clock of another packet processing device while controlling its own clock, and sets the clock frequency to a value in the neighborhood of the average value between the device concerned (itself and another device. Therefore, as described as the main feature of this embodiment, packets can be prevented from being missing and also the clock frequency of the overall network can be prevented from increasing.

Construction of Packet Processing Device

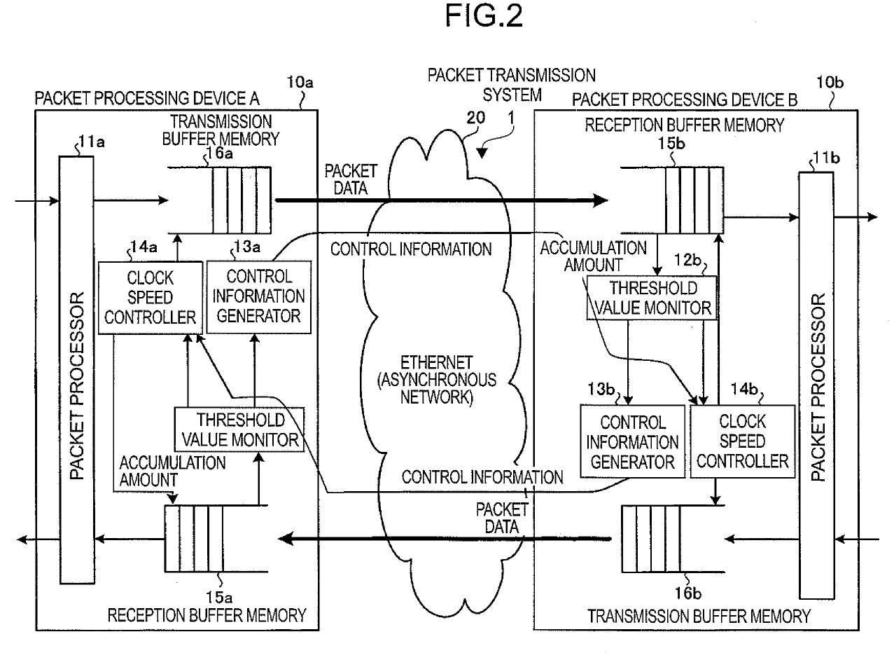

Next, the construction of the packet processing device 10a in the packet transmission system 1 shown in FIG. 1 will be described with reference to FIG. 2. FIG. 2 is a block diagram showing the construction of the packet processing device 10a according to the first embodiment. Other packet processing devices 10b-n would have the same construction as the packet processing device 10a.

As shown in FIG. 2, the packet processing device 10a has a packet processor 11a, a threshold value monitor 12a, a control information generator 13a, a clock speed controller 14a, a reception buffer memory 15a and a transmission buffer memory 16a, and it is connected to plural packet processing devices through ETHERNET 20 as an asynchronous network. The processing of each of these units will be described hereunder. The threshold value monitor 12a corresponds to “accumulation amount monitor”, the control information generator 13a corresponds to “clock information transmitter”, and the clock speed controller 14a corresponds to “clock controller for reception data processing” and “transmission clock controller” in claims.

The reception buffer 15a receives a packet transmitted (received), for example, from the packet processing device 10b and temporarily stores the packet. The transmission buffer 16a temporarily stores a packet to be transmitted, for example, to the packet processing device 10b.

The packet processor 11a processes a received packet or a packet to be transmitted. Specifically, the packet processor 11a reads out a packet stored in the reception buffer memory 15a and transmits the packet concerned to another packet processing device. The packet processor 11a stores a packet received from another packet processing device into the transmission buffer memory 16a, and transmits the packet to the packet processing device 10b.

The threshold value monitor 12a monitors the accumulation amount of the reception buffer 15a which receives a packet transmitted from the packet processing device 10b and temporarily stores the packet. Specifically, the threshold value monitor 12a judges whether the accumulation amount of the reception buffer is equal to a predetermined lower limit threshold value or less. When the accumulation amount of the reception buffer is equal to the predetermined lower limit threshold value or less, the threshold value monitor 12a notifies this fact to a clock speed controller 14a described later.

Furthermore, when the accumulation amount of the reception buffer is not equal to the predetermined lower limit threshold value or less, the threshold value monitor 12a judges whether the accumulation amount of the reception buffer is equal to a predetermined upper limit threshold value or more. When it is judged that the accumulation amount of the reception buffer is equal to the predetermined upper limit threshold value or more, the threshold value monitor 12a notifies this fact to a control information generator 13a described later and the clock speed controller 14a. When it is judged that the accumulation amount of the reception buffer is not equal to the predetermined upper limit threshold value or more, the threshold value monitor 12a returns to the processing of judging whether the accumulation amount of the reception buffer is equal to the predetermined lower limit threshold value or less.

On the basis of the monitored accumulation amount of the reception buffer, the control information generator 13a generates control information instructing to control the transmission clock in another packet processing device, and transmits the control information concerned to the packet processing device 10b. Specifically, for example, when the accumulation amount of the reception buffer is equal to the predetermined upper limit threshold value or more, the control information generator 13a generates control information instructing to reduce the clock speed in the packet processing device 10b, and transmits the control information concerned to the clock speed controller 14b of the packet processing device 10b. Furthermore, when the accumulation amount of the reception buffer is not equal to the predetermined upper limit threshold value or more, the control information generator 13a transmits control information instructing to permit release of the reduction of the clock speed to the packet processing device 10b.

On the basis of the monitored accumulation amount of the reception buffer, the clock speed controller 14a controls its own reception data processing clock. Specifically, when the accumulation amount of the reception buffer is equal to the predetermined upper limit threshold value or more, the clock speed controller 14a controls its own clock speed so that the clock speed concerned increases, speeding up transmission. When the accumulation amount of the reception buffer is equal to the predetermined lower limit threshold value or less, the clock speed controller 14a controls its own clock speed so that the clock speed concerned decreases, slowing down transmission.

Furthermore, the clock speed controller 14a receives control information from another packet processing device (e.g., from control information generator 13b of the packet processing device 10b) and controls its own transmission clock on the basis of the control information. The clock speed controller 14a continues to reduce the clock speed until it receives control information permitting release of the reduction of the clock speed from another packet processing device.

Processing of Packet Transmission System

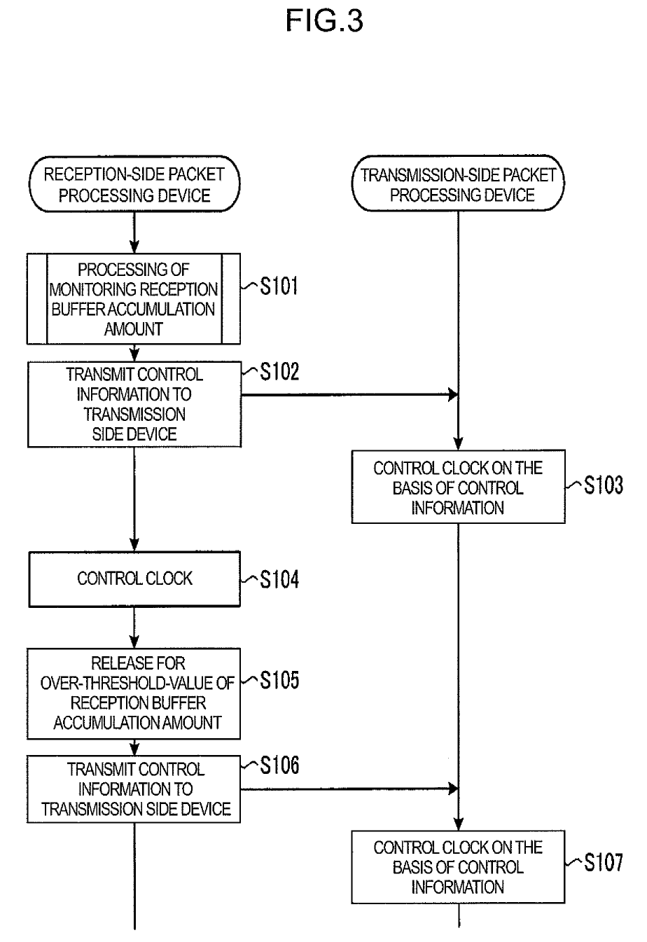

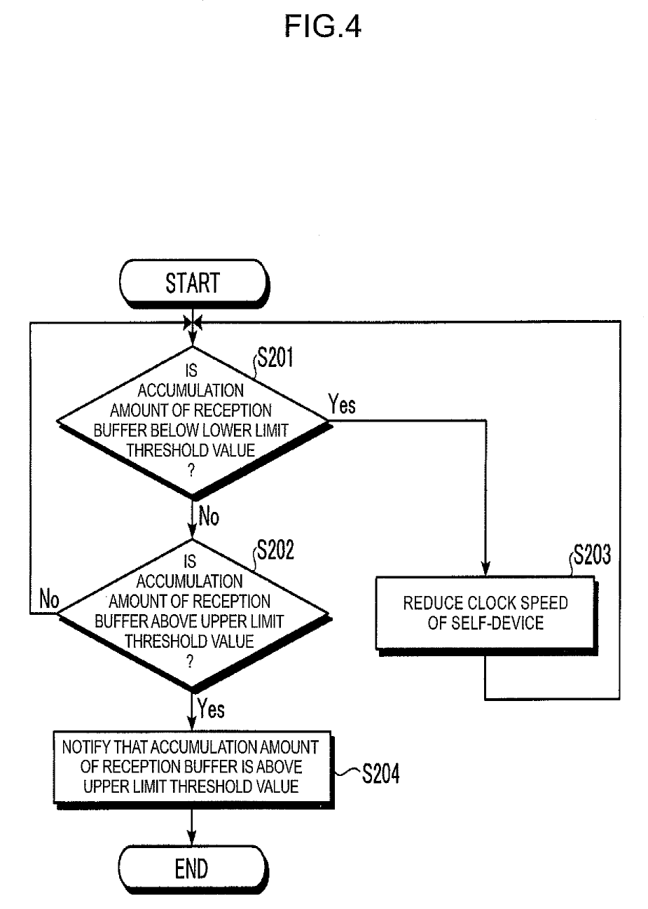

Next, the processing of the packet transmission system 1 according to the first embodiment will be described with reference to FIGS. 3 and 4. FIG. 3 is a sequence diagram showing the processing flow of the packet transmission system 1 according to the first embodiment, and FIG. 4 is a flowchart showing the processing flow of monitoring the accumulation amount of the reception buffer by the packet processing device according to the first embodiment.

As shown in FIG. 3, the packet processing device 10a at the reception side of the packet transmission system 1 executes the processing of monitoring the accumulation amount of the reception buffer (hereinafter referred to as “reception buffer accumulation amount monitoring processing”) (see FIG. 4) described later in detail while receiving a packet transmitted from the packet processing device 10b at the transmission side (S101).

Subsequently, when the accumulation amount of the reception buffer is equal to the predetermined upper limit threshold value or more (see S202 of FIG. 4 described later), the reception-side packet processing device 10a generates control information instructing that the clock speed is reduced, and transmits the control information concerned to the transmission-side packet processing device 10b (S102).

The transmission-side packet processing device 10b receives the control information transmitted from the reception-side packet processing device 10a, and controls its own transmission clock on the basis of the received control information (S103). The transmission-side packet processing device 10b continues to reduce the clock speed until it receives control information permitting release of the reduction of the clock speed from the reception-side packet processing device 10a.

Furthermore, after transmitting the control information to the transmission-side packet processing device 10b, the reception-side packet processing device 10a controls its own clock speed so that the clock speed concerned increases (S104), and when the accumulation amount of the reception buffer is not equal to the predetermined upper limit threshold value or more (S105), the reception-side packet processing device 10a transmits the control information permitting release of the reduction of the clock speed to the transmission-side packet processing device 10b (S106).

Thereafter, the transmission-side packet processing device 10b receives the control information permitting release of the reduction of the clock speed transmitted from the reception-side packet processing device 10a, and releases the reduction of the clock speed (i.e., stop reduction of the clock speed) on the basis of the received control information (S107).

Here, the reception buffer accumulation amount monitoring processing described above will be described with reference to FIG. 4.

As shown in FIG. 4, the threshold value monitor 12a judges whether the reception buffer accumulation amount is equal to the predetermined lower limit threshold value or less S201). When the reception buffer accumulation amount is equal to the predetermined lower limit threshold value or less (Yes in S201), the threshold value monitor 12a notifies this fact to the clock speed controller 14a. When receiving this notification, the clock speed controller 14 controls its own clock speed so that the clock speed concerned is reduced (S203), and the processing is returned to S201.

Furthermore, when the reception buffer accumulation amount is not equal to the predetermined lower limit threshold value or less (No in S201), the threshold value monitor 12a judges whether the reception buffer accumulation amount is equal to the predetermined upper limit threshold value or more (S202). When it is judged by the threshold value monitor 12a that the reception buffer accumulation amount is equal to the predetermined upper limit threshold value or more (Yes in S202), the threshold value monitor 12a notifies this fact to the control information generator 13a and the clock speed controller 14a (S204).

Furthermore, when the reception buffer accumulation amount is not equal to the predetermined upper limit threshold value or more (No in S202), the threshold value monitor 12a returns to the processing of judging whether the reception buffer accumulation amount is equal to the predetermined lower limit threshold value or less (S201).

### Effect of the First Embodiment

As described above, the packet processing device 10 of the packet transmission system 1 monitors the accumulation amount of the reception buffer 15a for receiving data transmitted from another packet processing device, transmitting to another data processing device transmission clock control information, thereby controlling available space or capacity of the reception buffer memory 15a on the basis of the monitored accumulation amount, controlling its own reception data processing clock on the basis of the monitored accumulation amount, and controlling its own transmission clock on the basis of the clock control information transmitted from another data processing device. Accordingly, the packet processing device controls the clock of another packet processing device while controlling its own clock, and sets the clock frequency to a value in the neighborhood of the average value between the packet processing device concerned (itself) and the other packet processing device. Therefore, packets can be prevented from being missing and also the clock frequency of the overall network can be prevented from increasing.

### Second Embodiment

In the first embodiment, the control information is transmitted/received independently of transmission/reception of the packet. However, the present embodiments are not limited to the above embodiment, and a transmission packet equipped with control information may be transmitted/received.

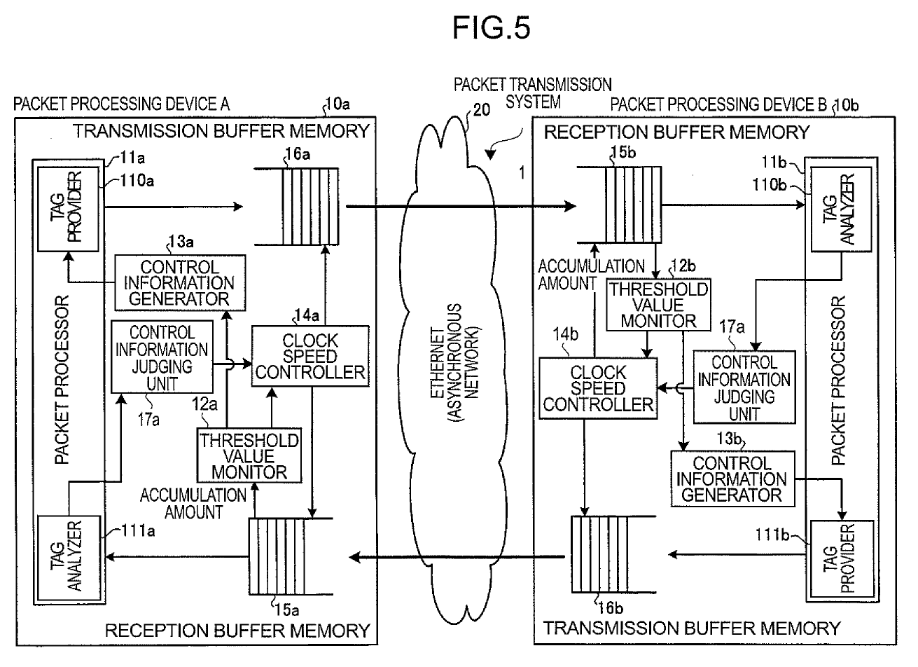

Therefore, in the following second embodiment, control information is embedded in a tag, the tag concerned is provided to a transmission packet, and the transmission packet concerned is transmitted to another packet processing device. The construction of a packet processing device 10 in a packet transmission system 1 according to a second embodiment will be described hereunder with reference to FIGS. 5 to 8.

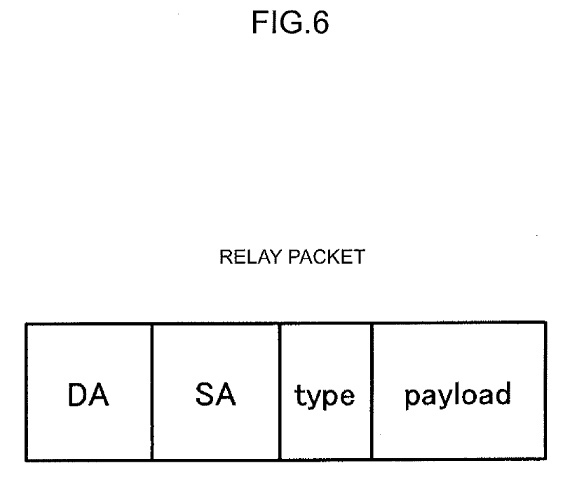

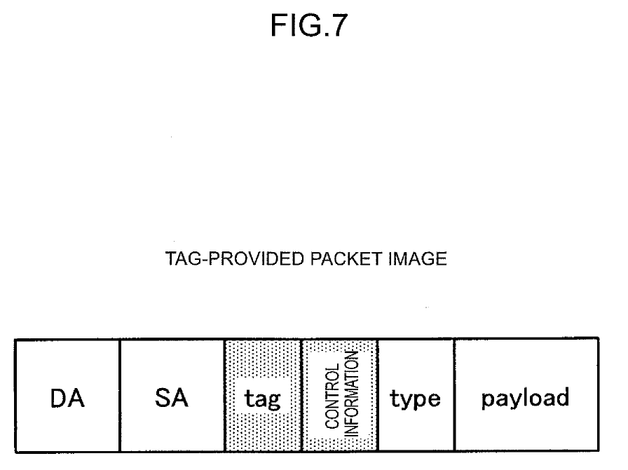

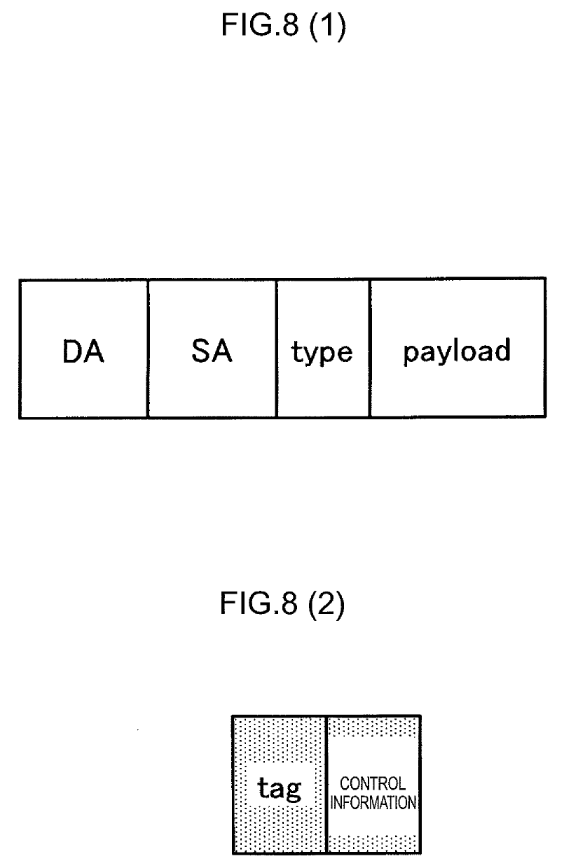

FIG. 5 is a block diagram showing the construction of the packet processing device according to the second embodiment, FIG. 6 is a diagram showing an example of a relay packet, FIG. 7 is a diagram showing an example of a packet provided with a tag, and FIG. 8 is a diagram showing separation of the tag from the packet.

As shown in FIG. 5, the packet processing device 10a according to the second embodiment is different from that of the first embodiment in that a tag provider 110a, a tag analyzer 111a and a control information judging unit 17a are newly equipped. The processing of these newly equipped units will be described.

The tag provider 110a embeds control information into a tag, and provides the tag to a transmission packet. Specifically, when receiving a relay packet as shown in FIG. 6, the tag provider 110a embeds a tag and control information generated by the control information generator 13a into the relay packet to generate a packet provided with the tag as shown in FIG. 7. Then, the tag provider 110a store the tag-attached packet in the transmission buffer memory 16a, and transmits it to the packet processing device 10b.

Furthermore, the tag analyzer 111a receives a tag-attached packet transmitted from the packet processing device 10b, and analyzes the tag of the received packet to extract control information. Specifically, the tag analyzer 111a receives a tag-attached packet through the reception buffer memory 15a, analyzes the tag of the received packet to extract control information, and notifies the control information to the control information judging unit 17a. That is, as shown in FIG. 8, the tag analyzer 111a separates the packet into the relay packet (see (1) in FIG. 8), and the tag and the control information (see (2) in FIG. 8), thereby extracting the control information.

The control information judging unit 17a judges on the basis of the control information how its own clock is controlled. Specifically, the control information judging unit 17a analyzes the control information notified from the tag analyzer 111a, judges on the basis of the analysis result how its own clock is controlled, and notifies the judgment result to the clock speed controller 14a. The clock speed controller 14a controls the clock speed in accordance with the notified judgment result.

According to the second embodiment, the packet processing device embeds control information in a tag, provides the tag concerned to the transmission data, and then transmits the tag-attached transmission data to another packet processing device. Furthermore, the packet processing device analyzes control information from a tag of transmission data transmitted from another device, and controls its own transmission clock on the basis of the control information. Therefore, the control information can be transmitted/received without reducing a band which data can normally use.

### Third Embodiment

In the first embodiment, the control information is transmitted independently of transmission/reception of the packet. However, the present embodiments are not limited to this embodiment, and control information may be transmitted while embedded in an inter-packet gap.

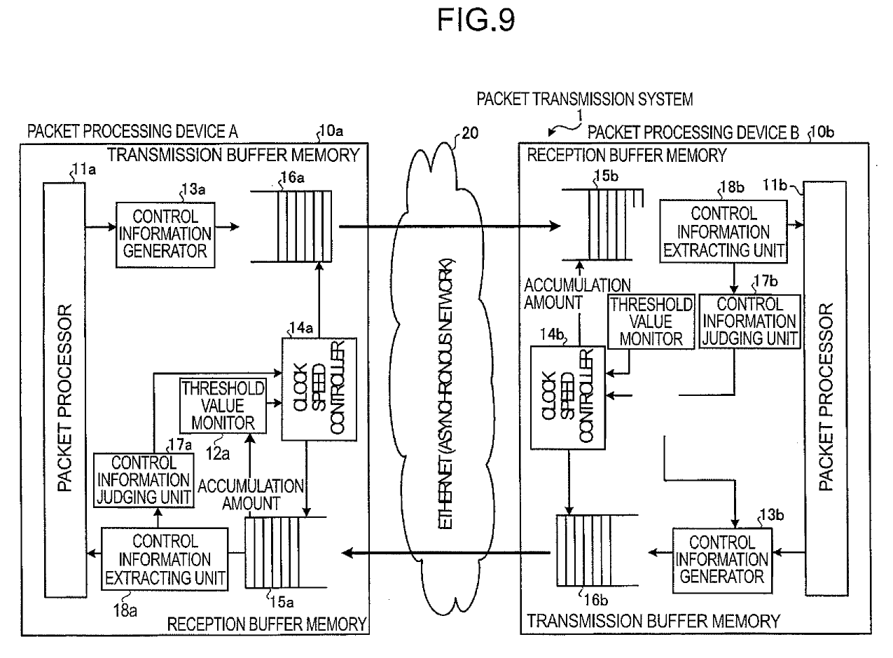

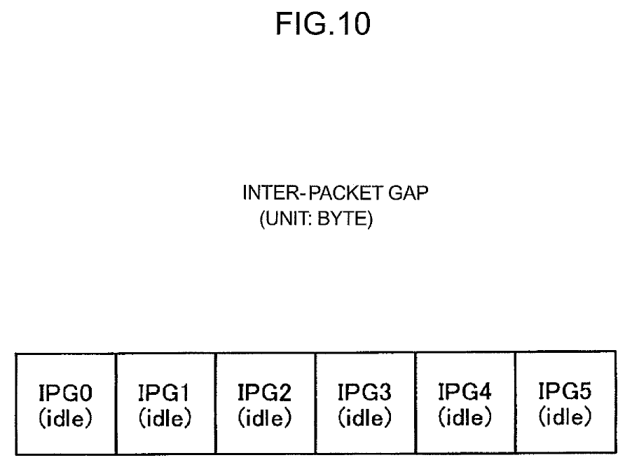

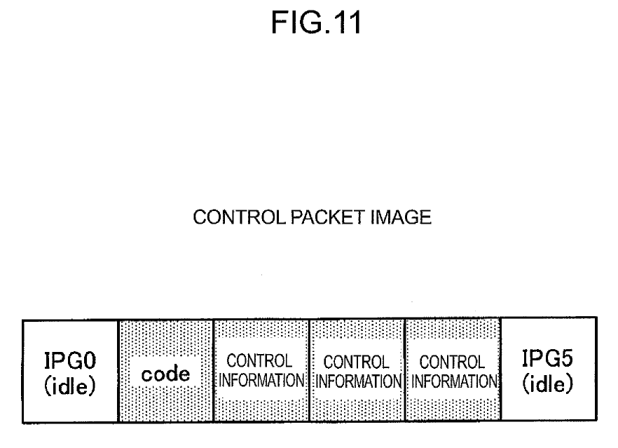

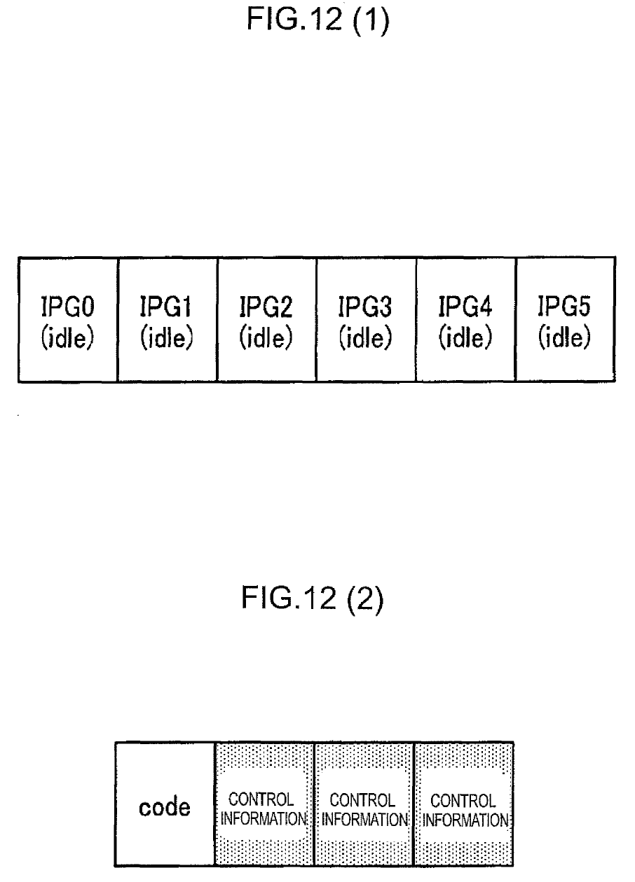

In the following third embodiment, control information is embedded in the inter-packet gap, the tag thereof is provided to a packet and then the tag-attached packet is transmitted to another data processing device. The construction of a packet processing device 10 in a packet transmission system 1 according to the third embodiment will be described with reference to FIGS. 9 to 12. FIG. 9 is a block diagram showing the construction of the packet processing device according to the third embodiment, FIG. 10 is a diagram showing an example of the inter-packet gap, FIG. 11 is a diagram showing an example of a control packet in the inter-packet gap, and FIG. 12 is a diagram showing extraction of control information.

As shown in FIG. 9, the packet processing device 10a according to the third embodiment is different from that of the first embodiment in that a control information judging unit 17a and a control information extracting unit 18a are newly equipped. The processing of each of these units will be described hereunder.

The control information generator 13a transmits control information while the control information is embedded in an inter-packet gap. Specifically, the control information generator 13a replaces IPG (inter Packet Gap)1 to IPG4 of inter-packet gaps shown in FIG. 10 by control information (see FIG. 11) to generate a control packet, store the control packet in the transmission buffer memory 16a and transmits the control packet to the packet processing device 10b.

The control information extracting unit 18a extracts control information embedded in an inter-packet gap. Specifically, as shown in FIG. 12, the control information extracting unit 18a extracts the control information from the received packet (see (2) in FIG. 12), and notifies it to the control information judging unit 17a. Furthermore, after the extraction of the control information, the control information extracting unit 18a returns the control information to IPG ((1) in FIG. 12), and notifies it to the packet processor 11a.

The control information judging unit 17a judges on the basis of the control information how its own clock is controlled. Specifically, the control information judging unit 17a analyzes the control information notified from the control information extracting unit 18a, judges on the basis of the analysis result how its own clock is controlled, and notifies the judgment result to the clock speed controller 14a. The clock speed controller 14a controls the clock speed in accordance with the notified judgment result.

As described above, according to the third embodiment, the control information is transmitted while embedded in the inter-data gap (inter-packet gap). Therefore, control information can be transmitted/received without reducing a band which data can normally use.

### Fourth Embodiment

The present embodiments are not limited to the above-described embodiments, and any combinations of the embodiments may be provided and various modifications may be made to these embodiments. Therefore, another embodiment will be described as a fourth embodiment.

(1) System Construction, Etc.

The respective constituent elements of the respective devices shown in the figures are functional and conceptual, and thus they are not necessarily limited to illustrated physical constructions. That is, dispersion/integration styles of the respective devices are not limited to the illustrated ones, and all or some of these constituent elements and devices may be functionally or physically dispersed/integrated in any unit in accordance with various kinds of loads, using condition, etc. For example, the threshold value monitor 12a and the control information generator 13a may be integrated with each other. Furthermore, all or some of the respective processing functions executed in the respective devices may be implemented by CPU and programs (software) which are analyzed and executed by CPU, or by hardware based on wired logic.

(2) Program

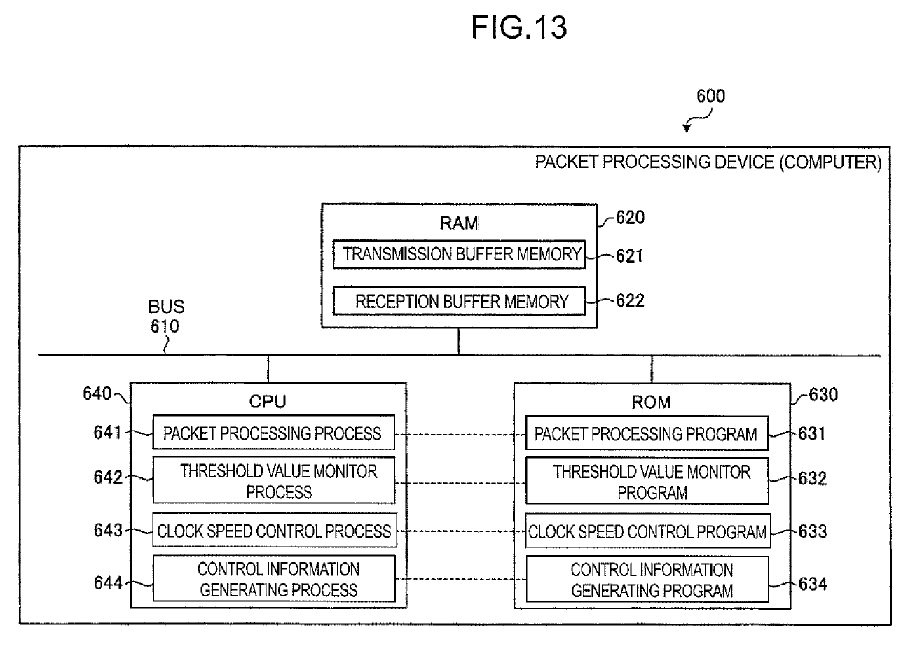

Various kinds of processing described in the above embodiments can be implemented by executing prepared programs by a computer. Therefore, an example of a computer executing programs having the same functions as the above-described embodiment will be described with reference to FIG. 13. FIG. 13 is a diagram showing a computer executing a packet processing program.

As shown in FIG. 13, a computer 600 as a packet processing device includes RAM 620, ROM 630 and CPU 640 which are connected to one another through a bus 610.

In ROM 630 are pre-stored a packet processing program exercising the same functions as the above-described embodiments, that is, a packet processing program 631, a threshold value monitoring program 632, a clock speed control program 633 and a control information generating program 634 as shown in FIG. 13. With respect to the programs 631 to 634, they may be properly integrated or dispersed as in the case of the respective constituent elements of the packet processing device shown in FIG. 2.

CPU 640 reads out these programs 631 to 634 from ROM 630 and executes the programs, whereby the respective programs 631 to 634 function as a packet processing process 641, a threshold value monitoring process 642, a clock speed control process 643 and a control information generating process 644 as shown in FIG. 13. The respective processes 641 to 644 correspond to the packet processor 11a, the threshold value monitor 12a, the control information generator 13a and the clock speed controller 14a shown in FIG. 2, respectively.

A transmission buffer memory 621 and a reception buffer memory 622 are provided to RAM 620 as shown in FIG. 13. The transmission buffer memory 621 and the reception buffer memory 622 correspond to the transmission buffer memory 16a and the reception buffer memory 15a shown in FIG. 2, respectively. CPU 640 registers data to the reception buffer memory 15a and the transmission buffer memory 16a, and also reads out packet data from the reception buffer memory 15a and the transmission buffer memory 16a and executes the processing.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A data processing device in communication with another data processing device through an asynchronous network the data processing device, comprising:
an accumulation amount monitor monitoring an accumulation amount of a reception buffer receiving data transmitted from the other data processing device;
a reception data processing clock controller controlling a self reception data processing clock based upon the monitored accumulation amount;
a clock information transmitter transmitting to the other data processing device transmission clock control information controlling a transmission clock in the other data processing device based upon the monitored accumulation amount; and
a transmission clock controller controlling a self transmission clock based upon the clock control information transmitted from the other data processing device.

2. The data processing device according to claim 1, wherein the clock information transmitter embeds the transmission clock control information into a tag, generates transmission data provided with the tag and transmits the tag-attached transmission data to the other data processing device, and the clock information controller analyzes the transmission clock control information from the tag of the transmission data transmitted from another data processing device, and controls the self transmission clock based upon the transmission clock control information.

3. The data processing device according to claim 1, wherein the clock information transmitter transmits the transmission clock control information in an inter-data gap.

4. A method of transmitting data between a data processing device in communication with another data processing device through an asynchronous network, comprising:
monitoring an accumulation amount of a reception buffer for receiving data transmitted from the other data processing device;
controlling a self reception data processing clock based upon the monitored accumulation amount;
transmitting to the other data processing device transmission clock control information controlling a transmission clock in the other data processing device based upon the monitored accumulation amount; and
controlling a self transmission clock based upon the clock control information transmitted from the other data processing device.

5. A computer readable recording medium having a data processing program stored therein for controlling a data processing device in communication with another data processing device through an asynchronous network, according to operations comprising:
monitoring an accumulation amount of a reception buffer receiving data transmitted from the other data processing device;
controlling a self reception data processing clock based upon the monitored accumulation amount;
transmitting to the other data processing device transmission clock control information controlling a transmission clock in the other data processing device based upon the monitored accumulation amount; and
controlling a self transmission clock based upon the clock control information transmitted from the other data processing device.

6. A data processing device in communication with another data processing device, the data processing device comprising:
a reception buffer; and
a controller
monitoring an accumulation amount of the reception buffer receiving data transmitted from the other data processing device,
controlling a self reception data processing clock based upon the monitored accumulation amount,
transmitting to the other data processing device transmission clock control information for controlling a transmission clock in the other data processing device based upon the monitored accumulation amount, and
controlling a self transmission clock based upon the clock control information transmitted from the other data processing device.
